(19) United States
(12) Patent Application Publication
(10) Pub. No.: US 2013/0046702 A1
(43) Pub. Date: Feb. 21, 2013

(54) PERFORMING FINANCIAL ACTIVITIES IN A SOCIAL NETWORKING ENVIRONMENT

(71) Applicants: Erik S. Ross, Charlotte, NC (US); Christopher M. Adams, Charlotte, NC (US); Katherine K. Dintenfass, Charlotte, NC (US); Carrie A. Hanson, Charlotte, NC (US); Alicia C. Jones, Fort Mill, SC (US); Jason Typrin, Charlotte, NC (US)

(72) Inventors: Erik S. Ross, Charlotte, NC (US); Christopher M. Adams, Charlotte, NC (US); Katherine K. Dintenfass, Charlotte, NC (US); Carrie A. Hanson, Charlotte, NC (US); Alicia C. Jones, Fort Mill, SC (US); Jason Typrin, Charlotte, NC (US)

(73) Assignee: Bank Of America Corporation, Charlotte, NC (US)

(21) Appl. No.: 13/209,740

(22) Filed: Aug. 15, 2011

(51) Int. Cl. G06Q 99/00; G06Q 40/00

(52) U.S. Cl. 705/319

(57) ABSTRACT

Financial activities may be performed in a social networking environment. To perform the financial activities, a first message is received to create a first financial goal associated with a user. The first message comprises the first financial goal and a reward for achieving the first financial goal. The first financial goal is available for display in a social networking environment associated with the user. A processor creates the first financial goal associated with the user and stores the first financial goal. The status of the first financial goal is monitored. Information associated with the first financial goal is received from a data source, and the processor updates the status of the first financial goal according to the received information.

### TECHNICAL FIELD OF THE INVENTION

This invention relates generally to social networking and, more specifically, to performing financial activities in a social networking environment.

### BACKGROUND

Social networking allows users to connect with various other users in an online environment. The social networks allow the users to interact with one another on a variety of topics and issues.

### SUMMARY OF THE DISCLOSURE

In accordance with the present invention, disadvantages and problems associated with performing financial activities in a social networking environment may be reduced or eliminated.

According to one embodiment of the present invention, financial activities may be performed in a social networking environment. To perform the financial activities, a first message is received to create a first financial goal associated with a user. The first message comprises the first financial goal and a reward for achieving the first financial goal. The first financial goal is available for display in a social networking environment associated with the user. A processor creates the first financial goal associated with the user and stores the first financial goal. The status of the first financial goal is monitored. Information associated with the first financial goal is received from a data source, and the processor updates the status of the first financial goal according to the received information.

Certain embodiments of the invention may provide one or more technical advantages. A technical advantage of one embodiment includes providing financial goal information in a social networking environment to allow one or more users to create, update, or negotiate the financial goals, rewards for achieving the goal, and interim goal rewards for milestone achievements. Additionally, the users in the social networking environment may provide feedback on the financial goal, provide behavior modification suggestions to attain the goal, and provide support for behaviors to achieve the financial goal. Another technical advantage of one embodiment includes allowing users in a social networking environment to be connected to other users throughout the process of attempting to reach a financial goal and facilitating execution of a reward mechanism when the financial goal is obtained.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 illustrates a system that provides for performing financial activities in a social networking environment;

FIG. 2 illustrates a particular embodiment of a memory in a financial goal module that stores financial goals associated with a user; and

FIG. 3 illustrates a flowchart for performing financial activities in a social networking environment.

### DETAILED DESCRIPTION OF THE DRAWINGS

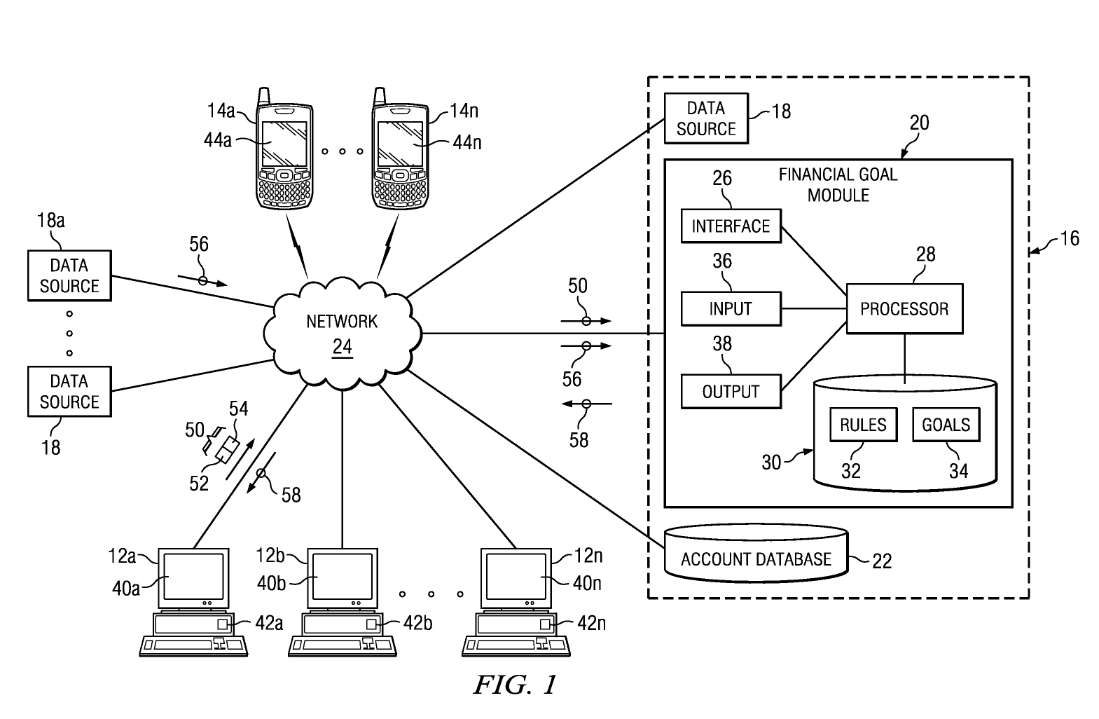

Embodiments of the present invention and its advantages are best understood by referring to FIGS. 1 through 3, like numerals being used for like and corresponding parts of the various drawings.

FIG. 1 illustrates a system 10 that provides for performing financial activities in a social networking environment. System 10 includes one or more computers 12 and one or more mobile devices 14 that communicate over one or more networks 24 to facilitate the performance of financial activities in a social networking environment. Computer 12 and mobile device 14 interact with financial goal module 20 to establish goals for financial activities, and financial goal module 20 interacts with data sources 18 to gather information about the financial goals and interacts with account database 22 to gather financial information associated with a user.

When interacting within a social network, a user may desire to bridge the gap between their social network and their financial activities. The social networking environment allows users to be connected to other users throughout the process of attempting to reach a financial goal and facilitates execution of a reward mechanism when the financial goal is obtained. For example, a user may desire to inform friends or family members about a financial goal in an online environment and receive support while trying to attain that goal or receive a reward from another user upon completing a financial goal. The user may provide various levels of authorization to certain other users in the social network with respect to the financial goals. For example, other users may have permission to view the financial goal, comment on the financial goal, update the financial goal, contribute towards the financial goal, view the user's social network, update the user's social network, or any other permission. The social networking environment may include an online social network or a standalone financial social network, and the financial social network may be associated with a financial institution. The teachings of the disclosure recognize that it would be desirable to consider utilization of the social networking environment to perform financial activities.

System 10 includes computers 12a-12n, where n represents any suitable number, that communicate with financial goal module 20 through network 24. Computer 12 may include a personal computer, a workstation, a laptop, a wireless or cellular telephone, an electronic notebook, a personal digital assistant, or any other device (wireless, wireline, or otherwise) capable of receiving, processing, storing, and/or communicating information with other components of system 10.

A user of computer 12 may participate in social networking using computer 12. While in a social networking environment, a user of computer 12 may create a financial goal, update a financial goal, create a reward associated with a financial goal, update the associated reward, provide and/or receive feedback regarding the financial goal, and/or receive other information regarding the financial goal from other users in the social network. The user of computer 12 may submit predefined parameters to financial goal module 20 to create the financial goal. Additionally, a user of computer 12 may receive information regarding the financial goal and/or the associated reward information in any suitable format on computer 12. Computer 12 may also comprise a user interface, such as a display, a microphone, keypad, or other appropriate terminal equipment usable by a user.

In the illustrated embodiment, computer 12 includes a graphical user interface (“GUI”) 40 that displays information received from financial goal module 20. GUI 40 is generally operable to tailor and filter data entered by and presented to the user. GUI 40 may provide the user with an efficient and user-friendly presentation of information. For example, GUI 40 may display the financial goals of a user to members of a social network in any suitable format, such as a bar graph, a pie chart, a line graph, a chart and may display any suitable type of information related to the financial goals or the rewards. As another example, GUI 40 may display visual indications of goal achievement, goal status, and comments associated with the goal. GUI 40 may comprise a plurality of displays having interactive fields, pull-down lists, and buttons operated by the user. GUI 40 may include multiple levels of abstraction including groupings and boundaries. It should be understood that the term GUI 40 may be used in the singular or in the plural to describe one or more GUIs 40 in each of the displays of a particular GUI 40.

Computer 12 also includes an application 42. Application 42 represents any suitable software or logic that allows a user to interact with financial goal module 20 by transmitting requests and information to and receiving information from financial goal module 20. A user may enter access credentials into application 42 to interact with financial goal module 20. The access credentials may include a username and/or a password.

Mobile device 14 may include, for example, a wireless or cellular telephone, an Internet Protocol (IP) telephone, a mobile handset, a computer supporting a telephony application, a Personal Digital Assistant (PDA), or any other endpoint suitable for communicating in system 10. Mobile device 14 may support, for example, IP, mobile IP, Session Initiation Protocol (SIP), Media Gateway Control Protocol (MGCP), H.248, H.323, other suitable device or call control communication protocols, or any suitable combination of the preceding. Mobile device 14 includes hardware, software, or any suitable combination of the preceding.

A user of mobile device 14 may participate in social networking using mobile device 14. While in a social networking environment, a user of mobile device 14 may create a financial goal, update a financial goal, create a reward associated with a financial goal, update the associated reward, provide and/or receive feedback regarding the financial goal, and/or receive other information regarding the financial goal from other users in the social network. The user of mobile device 14 may submit predefined parameters to financial goal module 20 to create the financial goal. Additionally, a user of mobile device 14 may receive information regarding the financial goal and/or the associated reward information in any suitable format on mobile device 14. Mobile device 14 may also comprise a user interface, such as a display, a microphone, keypad, or other appropriate terminal equipment usable by a user.

In the illustrated embodiment, mobile device 14 includes a GUI 44 that displays information received from financial goal module 20. GUI 44 is generally operable to tailor and filter data entered by and presented to the user. GUI 44 may provide the user with an efficient and user-friendly presentation of information. For example, GUI 44 may display the financial goals of a user to members of a social network in any suitable format, such as a bar graph, a pie chart, a line graph, a chart and may display any suitable type of information related to the financial goals or the rewards. As another example, GUI 44 may display visual indications of goal achievement, goal status, and comments associated with the goal. GUI 44 may comprise a plurality of displays having interactive fields, pull-down lists, and buttons operated by the user. GUI 44 may include multiple levels of abstraction including groupings and boundaries. It should be understood that the term GUI 44 may be used in the singular or in the plural to describe one or more GUIs 44 in each of the displays of a particular GUI 44.

Enterprise 16 may refer to a financial institution, such as a bank, brokerage house, or investment firm, that communicates with computers 12, mobile phones 14, and data sources 18 to provide information regarding financial accounts, products, and services. In the illustrated embodiment, enterprise 16 includes a data source 18, a financial goal module 20, and an account database 22.

Data sources 18 represent components that provide information associated with a financial goal to financial goal module 20. For example, data source 18 may include detailed information about a reward associated with a goal. In another embodiment, data source 18 may include information about investment vehicles that may be used to facilitate achievement of the financial goal. In yet another embodiment, data source 18 represents a component that hosts the social networking environment. In this embodiment, financial goal module 20 and data source 18 interact to facilitate the performance of financial activities in the social networking environment.

Data sources 18 may include a network server, any suitable remote server, a mainframe, a host computer, a workstation, a web server, a personal computer, a file server, or any other suitable device operable to communicate with other components in system 10 and process data. In some embodiments, data source 18 may execute any suitable operating system such as IBM's zSeries/Operating System (z/OS), MS-DOS, PC-DOS, MAC-OS, WINDOWS, a .NET environment, UNIX, OpenVMS, or any other appropriate operating system, including future operating systems. The functions of data source 18 may be performed by any suitable combination of one or more servers or other components at one or more locations. In the embodiment where the module is a server, the server may be a private server, and the server may be a virtual or physical server. For example, data source 18 may be local to enterprise 16 or remote to enterprise 16. Also, data source 18 may include any suitable component that functions as a server.

Financial goal module 20 represents any suitable component that facilitates the performance of financial activities in a social networking environment. In an embodiment, financial goal module 20 facilitates the creation and negotiation of a financial goal by a user or among multiple users. Financial goal module 20 may also facilitate the creation and negotiation of rewards associated with the financial goal. In a particular embodiment, financial goal module 20 implements predefined rules to prioritize a plurality of financial goals associated with a user. In another embodiment, financial goal module 20 monitors the progress of the financial goal and periodically provides updates on the financial goal.

Financial goal module 20 may include a network server, any suitable remote server, a file server, or any other suitable device operable to communicate with computers 12, mobile devices 14, data sources 18, and account database 22 and receive and process data related to financial goals. In some embodiments, financial goal module 20 may execute any suitable operating system such as IBM's, z/OS, MS-DOS, PC-DOS, MAC-OS, WINDOWS, UNIX, OpenVMS, or any other appropriate operating system, including future operating systems. The functions of financial goal module 20 may be performed by any suitable combination of one or more servers or other components at one or more locations. In the embodiment where the modules are servers, the servers may be public or private servers, and each server may be a virtual or physical server. The server may include one or more servers at the same or at remote locations. Also, financial goal module 20 may include any suitable component that functions as a server. In the illustrated embodiment, financial goal module 20 includes a network interface 26, a processor 28, a memory 30, an input device 36, and output device 38.

Network interface 26 represents any suitable device operable to receive information from network 24, transmit information through network 24, perform suitable processing of the financial goals data, communicate to other devices, or any combination of the preceding. For example, network interface 26 receives requests from computer 12 or mobile device 14 to create a financial goal that has a particular reward associated with achieving the financial goal. To create the financial goal, network interface 26 may also receive data from data sources 18 and account database 22. Network interface 26 represents any port or connection, real or virtual, including any suitable hardware and/or software, including protocol conversion and data processing capabilities, to communicate through a LAN, WAN, or other communication system that allows financial goal module 20 to exchange information with computers 12, mobile devices 14, data sources 18, account database 22, network 24, or other components of system 10.

Processor 28 communicatively couples to network interface 26 and memory 30, and controls the operation and administration of financial goal module 20 by processing information received from network interface 26 and memory 30. Processor 28 includes any hardware and/or software that operates to control and process information. For example, processor 28 executes rules 32 to control the operation of financial goal module 20. Processor 28 may be a programmable logic device, a microcontroller, a microprocessor, any suitable processing device, or any suitable combination of the preceding.

Memory 30 stores, either permanently or temporarily, data, operational software, or other information for processor 28. Memory 30 includes any one or a combination of volatile or non-volatile local or remote devices suitable for storing information. For example, memory 30 may include random access memory (RAM), read only memory (ROM), magnetic storage devices, optical storage devices, or any other suitable information storage device or a combination of these devices. While illustrated as including particular modules, memory 30 may include any suitable information for use in the operation of financial goal module 20.

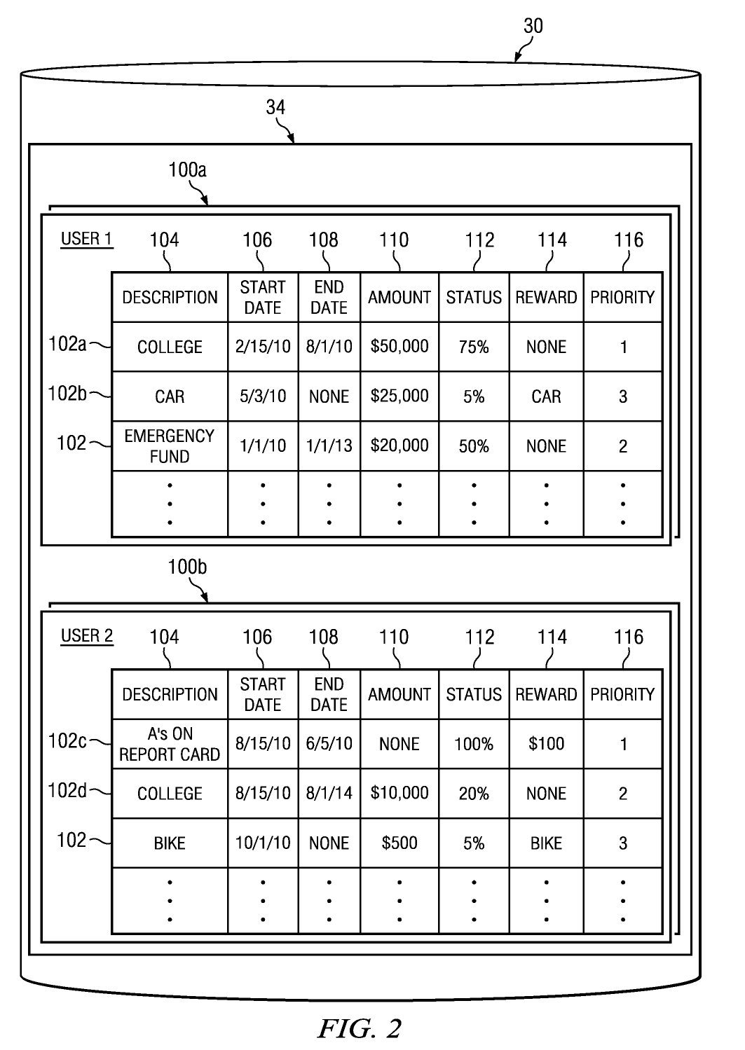

In the illustrated embodiment, memory 30 includes rules 32 and goals database 34. Rules 32 generally refer to logic, rules, standards, policies, limitations, tables, and/or other suitable instructions for processing the financial goals and associated information received from computers 12, mobile devices 14, data sources 18, and account database 22. Rules 32 may include logic to create the financial goals, associate rewards with financial goals, determine the status of the financial goals, prioritize financial goals, manage the financial goals and rewards, or other suitable logic to process the financial goals. Goals database 34 generally refers to the database that stores financial goals associated with a user. The organization of goals database 34 and the information related to the goals will be described in further detail with respect to FIG. 2.

In some embodiments, input device 36 may refer to any suitable device operable to input, select, and/or manipulate various data and information. Input device 36 may include, for example, a keyboard, mouse, graphics tablet, joystick, light pen, microphone, scanner, or other suitable input device. Output device 38 may refer to any suitable device operable for displaying information to a user. Output device 38 may include, for example, a video display, a printer, a plotter, or other suitable output device.

Account database 22 stores, either permanently or temporarily, data related to a user's financial accounts. For example, account database 22 includes information about a user's investments, checking accounts, savings accounts, or other types of financial accounts, such as account balance, interest rate, and/or transaction history. Account database 22 includes any one or a combination of volatile or non-volatile local or remote devices suitable for storing information. For example, account database 22 may include RAM, ROM, magnetic storage devices, optical storage devices, or any other suitable information storage device or combination of these devices. In an embodiment, account database 22 represents a data source 18 that provides information to financial goal module 20 regarding financial accounts. Financial goal module 20 may use the account information to update the financial goals accordingly.

Network 24 represents any suitable network operable to facilitate communication between the components of system 10, such as financial goal module 20 and computers 12 and data sources 18. Network 24 may include any interconnecting system capable of transmitting audio, video, signals, data, messages, or any combination of the preceding. Network 14 may include all or a portion of a public switched telephone network (PSTN), a public or private data network, a local area network (LAN), a metropolitan area network (MAN), a wide area network (WAN), a local, regional, or global communication or computer network, such as the Internet, a wireline or wireless network, an enterprise intranet, or any other suitable communication link, including combinations thereof, operable to facilitate communication between the components.

In an exemplary embodiment of operation, financial goal module 20 receives a message 50 from computer 12a to create a financial goal. In an embodiment, message 50 includes financial goal 52 and an associated reward 54. Financial goal 52 may be a savings goal, a charitable goal, a home, a vacation, a vehicle, an investment, a retirement plan, a 529 account, a tuition fund, or any other desirable financial goal. Each financial goal 52 may have one or more associated rewards 54. Each associated reward 54 may be different and may come from various sources. Reward 54 may be a purchase, a charitable gift, a monetary award, a vacation, a vehicle, or other desirable reward that incentivizes achievement of the goal. Reward 54 may be an incremental reward or a completion reward. The incremental reward represents a reward associated with incremental achievements of financial goal 52. For example, a user may receive a monetary reward for reaching 50% of the total financial goal 52. As another example, a user may receive a monetary reward for achieving certain grades on a report card each semester. The incremental reward may be based on time, progress status of financial goal 52, or level of achievement. The incremental progression may be reflected as a percentage or a dollar amount. The completion reward represents a reward for completing the entire financial goal 52. For example, a completion reward may be an item for which money is being saved or an additional monetary incentive.

Financial goal module 20 creates financial goal 52 based on message 50 and stores financial goal 52 in memory. Financial goal 52 is displayed in a social networking environment. By providing financial goal 52 in a social networking environment, one or more users may create, update, or negotiate the financial goals, rewards for achieving the goal, and interim goal rewards for milestone achievements. Additionally, the users in the social networking environment may provide feedback on the financial goal, provide behavior modification suggestions to attain the goal, and provide support for behaviors to achieve the financial goal. Financial goal module 20 monitors the status of financial goal 52.

While monitoring the status of financial goal 52, financial goal module 20 receives information 56 associated with financial goal 52 from data source 18a. Information 56 may include data regarding reward 54, data regarding financial goal 52, transaction history associated with financial goal 52, interest rate updates, investment updates, or other suitable information. In an embodiment, the user progress towards the financial goal by depositing funds into financial accounts, such as a savings account, an investment account, a checking account, or a combination of accounts; exercising stock options; receiving donations; fund raising; collecting coupons; or any other method to acquire funds. Based on information 56, financial goal module 20 updates the status of financial goal 52 accordingly.

When the status has been updated, financial goal module 20 determines whether there is an associated reward 54. Financial goal module 20 determines reward 54 and communicates notification 58 to computer 12a that identifies reward 54. Computer 12a interacts in the social networking environment and the achieved reward 54 may be displayed in the user's social network.

Financial goal module 20 continues to monitor financial goal 52 and communicates information regarding achieved incremental rewards 54 until the completion of the financial goal. Once financial goal 52 has been obtained, financial goal module 20 determines reward 54 associated with the completed goal and communicates reward 54 to computer 12. Throughout the existence of financial goal 52, users may use the social networking environment to modify financial goal 52, provide feedback on a created financial goal 52, determine status of financial goal 52, receive reward information associated with financial goal 52, or perform any other suitable financial activity.

A component of system 10 may include an interface, logic, memory, and/or other suitable element. An interface receives input, sends output, processes the input and/or output and/or performs other suitable operations. An interface may comprise hardware and/or software. Logic performs the operation of the component, for example, logic executes instructions to generate output from input. Logic may include hardware, software, and/or other logic. Logic may be encoded in one or more tangible media, such as a computer-readable medium or any other suitable tangible medium, and may perform operations when executed by a computer. Certain logic, such as a processor, may manage the operation of a component. Examples of a processor include one or more computers, one or more microprocessors, one or more applications, and/or other logic.

Modifications, additions, or omissions may be made to system 10 without departing from the scope of the invention. For example, any suitable component, such as computer 12 or mobile device 14, may create a financial goal in the social networking environment. As another example, a plurality of users may create the financial goal. In an embodiment, financial goal module 20 may receive a message to create a financial goal based on location information of the user. As a specific example, a user identifies an object to purchase, but does not have the money to purchase the item immediately. The user may decide to create a financial goal to save money to purchase the item. In this example, the user may take a picture of the item using mobile device 14 or may input a description regarding the item into mobile device 14 or a computer 14, and the collected information is communicated to financial goal module 20. In another embodiment, mobile device 14 may learn information about an object to which mobile device 14 is directed. Mobile device 14 may then communicate the learned information to financial goal module 20 to facilitate creation of a goal. Financial goal module 20 receives the message and creates the associated financial goal. If the picture or description does not have enough information to allow financial goal module 20 to create the financial goal, financial goal module 20 may interact with data sources 18 to compile the additional information necessary to create the financial goal. Additionally, system 10 may include any number of computers 12, mobile devices 14, data sources 18, financial goal modules 20, account databases 22, and networks 24. Any suitable logic may perform the functions of system 10 and the components within system 10.

FIG. 2 illustrates a particular embodiment of a memory 30 in a financial goal module 20 that stores financial goals 52 associated with a user. Goals 52 may be stored in financial goal module memory 30 or may be stored in an external network storage device. Financial goal module memory 30 stores each created goal in goals database 34. The goals may be stored in an organized manner within goals database 34. In an embodiment, goals database 34 organizes financial goals 52 into separate user goals charts 100. In the illustrated embodiment, goals chart 100a represents the financial goals for User 1, and goals chart 100b represents the financial goals for User 2. Each goals chart 100 may organize the information into goals records 102. Each goals record 102 is related to a financial goal of a user, and each goal record 102 may have associated information provided in specific fields.

In certain embodiments, goal record 102 may include the following fields: description field 104, start date field 106, end date field 108, amount field 110, status field 112, reward field 114, and priority field 116. Description field 104 includes a description of the financial goal. Start date field 106 includes the date when the user creates the financial goal. In the illustrated embodiment, start date is represented as the month, day, and year. End date field 108 includes the date when the financial goal should be completed. For example, a financial goal may have an end date because a user will need to access the money associated with the financial goal. As another example, goal record 102 may include a end date to encourage the user to achieve the goal within a limited amount of time. As yet another example, goal record 102 may not include an end date. In the illustrated embodiment, end date is represented as the month, day, and year.

Amount field 110 includes the amount necessary to achieve the financial goal. In an embodiment, goal record 102 may not have a particular amount associated with goal record 102. Status field 112 includes information regarding the current status of the financial goal. In the illustrated embodiment, the status is represented as a percentage completion of the financial goal. In other embodiments, status field 112 may include a description of the status, a numerical value, a picture, a graph, a chart, or any other representative data. Reward field 114 includes the reward associated with the financial goal. For example, the description of the financial goal may be the reward also. As another example, the financial goal may not include an associated reward. As yet another example, the reward may be a monetary award based on achievement of the goal identified in description field 104. Priority field 116 includes the priority of the financial goal in relation to the other financial goals associated with a user. In the illustrated embodiment, the priority is identified numerically. In other embodiments, the priority may be identified by urgency (High, Medium, or Low) or any other suitable identification. Each field is included for each goal record 102 in goals chart 100.

After receiving information from computers 12, mobile devices 14, data sources 18, and/or account database 22, financial goal module 20 may incorporate the received information into various fields of goal record 102 or may use the received information to analyze the financial goal and update various fields based on the analysis. For example, financial goal module 20 receives the financial goal, the start date, end date, amount, and reward from computer 12 and populates goal record 102 with that information. Financial goal module 20 receives information from account database 22 regarding the transaction history of an account associated with the financial goal and updates status field 112 accordingly. As another example, as financial goal module 20 receives more than one financial goal associated with a user, financial goal module 20 determines the priority of the financial goals and updates priority field 116 accordingly.

In the illustrated embodiment, goal record 102a illustrates User 1's goal of saving for college. Goal record 102b illustrates User 1's goal of purchasing a car. Goal record 102c illustrates User 2's goal of achieving A′s on a report card, and goal record 102d illustrates User 2's goal of saving for college.

In each goal record 102, the information received from computer 12 or mobile device 14 are shown in various fields, and the calculations completed by financial goal module 20 based on received information are also shown in the fields. For example, goal record 102a has a start date of Feb. 15, 2010 and an end date of Aug. 1, 2010. The start date indentifies when the user created the financial goal and the end date identifies when the goal needs to be achieved. In goal record 102b, the financial goal does not have an end date because the goal does not have a defined achievement period. Each of goal records 102a, 102b, and 102d includes an associated amount of the goal. Goal record 102c does not include an associated goal amount because the achievement of the goal is based on non-monetary actions. Each goal record 102a, 102b, 102c, and 102d indicates the status of the financial goal. Financial goal module 20 updates status field 112 based on information received from computers 12, mobile devices 14, or data sources 18. In the illustrated embodiment, goal record 102a does not include an associated reward, goal record 102b includes a reward that coincides with the description, and goal record 102c includes a monetary reward for achieving the goal.

Modifications, additions, or omissions may be made to memory 30 and goals database 34. For example, any suitable component within system 10 may include goals database 34. As another example, each goals chart 100 may include any suitable number and type of records and fields based on the financial goals. As yet another example, goals charts 100 may be organized into folders according to any suitable criteria. For example, goals charts 100 may be organized according to the user, a group of associated users, or other suitable organization criteria. In another embodiment, each goal record 102 may have an associated history log. The history log may include the date and/or time of the progression steps towards the financial goal, posted comments related to the progress towards the financial goal, or other suitable historical information regarding the financial goal.

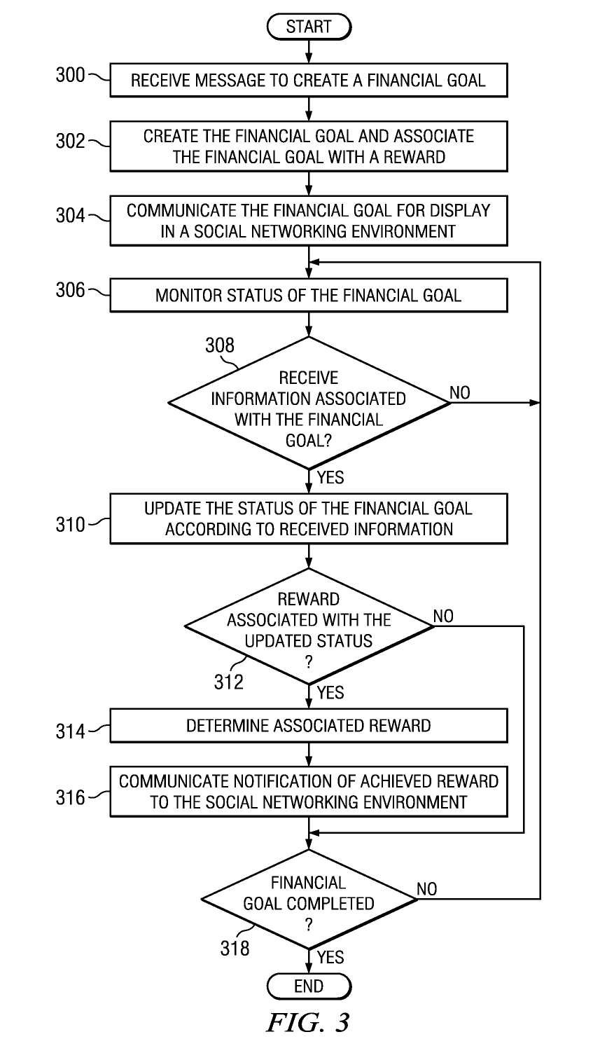

FIG. 3 illustrates a flowchart for performing financial activities in a social networking environment. The method begins in step 300 where financial goal module 20 receives a message to create a financial goal. A single user or a group of users may be associated with the financial goal. For example, a husband and wife, a group of friends, an organization, a school, a charity, or any other group that shares a financial goal may be associated with a created goal. Financial goal module 20 may receive the message from computer 12 or mobile device 14. At step 302, financial goal module 20 creates the financial goal and associates the financial goal with a reward. Financial goal module 20 communicates the financial goal for display in a social networking environment.

At step 306, financial goal module 20 monitors the status of the financial goal. Financial goal module 20 determines whether it has received information associated with the financial goal at step 308. Financial goal module 20 may receive the information from computer 12, mobile device 14, data source 18, or account database 22. In an embodiment, financial goal module 20 queries data sources 18 or account database 22 to obtain information regarding the status of the financial goal. In another embodiment, data sources 18 or account database 22 may push information to financial goal module 20 when a status update occurs. If financial goal module 20 does not receive any information, the method continues from step 306 by monitoring the status of the financial goal. If financial goal module 20 receives information associated with the financial goal, financial goal module 20 updates the status of the financial goal according to the received information at step 310. For example, financial goal module 20 receives updated account information from account database 22, and financial goal module 20 updates the status of the financial goal based on the account's transaction history. In an embodiment, financial goal module 20 communicates the associated transaction information for display in the social networking environment. Users in the social network may also comment on the transaction information. As another example, financial goal module 20 receives information from data source 18 regarding a user's grades on a report card. Financial goal module 20 may determine whether the grades coincide with the user's goal and process the status accordingly.

At step 312, financial goal module 20 determines whether there is a reward associated with the updated status. If there is not a reward, the method proceeds to step 318. If there is an associated reward, financial goal module 20 determines the reward at step 314, and communicates notification of the achieved reward to the social networking environment at step 316. In an embodiment, financial goal module 20 may execute upon the associated reward. For example, a first user may create a financial goal to stay within $100 of expenses for a predetermined time period. The reward for attaining the financial goal may include depositing $100 into the first user's savings account from a second user's checking account. Upon determining that the first user achieves the goal, financial goal module 20 accesses the second user's checking account, withdraws $100, and deposits $100 into the first user's savings account. A third user in the social network may also provide a reward if the first user achieves the financial goal. The reward from the third user may be the same or different from the second user's award.

At step 318, financial goal module 20 determines whether the financial goal is complete. If the determination is no, the method proceeds from step 306 and financial goal module 20 continues to monitor the status of the financial goal. Otherwise, the method ends upon completion of the financial goal.

Modifications, additions, or omissions may be made to the flowchart. For example, financial goal module 20 may receive a message from computer 12 or mobile device 14 to update the financial goal or update the reward associated with the financial goal. As another example, financial goal module 20 may receive a plurality of other messages to create financial goals associated with a user. The additional financial goals are created and available for display in the social networking environment associated with the user. When financial goal module 20 creates more than one financial goal for a user, financial goal module 20 determines a priority between the financial goals and prioritizes the goals accordingly. Goals may be prioritized based on predefined user preferences, financial account history of the user, a comparison between the status of the financial goals, or any other suitable prioritization information. Additionally, steps in FIG. 3 may be performed in parallel or in any suitable order.

Certain embodiments of the invention may provide one or more technical advantages. A technical advantage of one embodiment includes providing financial goal information in a social networking environment to allow one or more users to create, update, or negotiate the financial goals, rewards for achieving the goal, and interim goal rewards for milestone achievements. Additionally, the users in the social networking environment may provide feedback on the financial goal, provide behavior modification suggestions to attain the goal, and provide support for behaviors to achieve the financial goal. Another technical advantage of one embodiment includes allowing users in a social networking environment to be connected to other users throughout the process of attempting to reach a financial goal and facilitating execution of a reward mechanism when the financial goal is obtained.

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims.

What is claimed is:

1. A system for performing financial activities in a social networking environment, comprising:
a network interface operable to receive a first message to create a first financial goal associated with a user, wherein the first message comprises the first financial goal and a reward for achieving the first financial goal and the first financial goal is available for display in a social networking environment associated with the user;
a processor communicatively coupled to the network interface, the processor operable to create the first financial goal associated with the user; and
a memory communicatively coupled to the processor, the memory operable to store the first financial goal;
wherein the processor is further operable to monitor a status of the first financial goal, the network interface is further operable to receive information associated with the first financial goal from a data source, and the processor is further operable to update the status of the first financial goal according to the received information.

2. The system of claim 1, wherein:
the processor is further operable to:
determine whether a reward is associated with the updated status of the first financial goal;
if a reward is associated with the updated status, determine the reward; and
the network interface is further operable to communicate a notification to a computer that indicates the reward.

3. The system of claim 1, wherein the network interface is operable to receive a message to update the first financial goal associated with the user, wherein the second message comprises at least one of the following:
an update to the first financial goal; and
an update to the reward.

4. The system of claim 1, wherein the processor is further operable to:
determine completion of the first financial goal; and
determine the reward associated with the completed first financial goal.

5. The system of claim 1, wherein the reward comprises a selected one of the following:
an incremental reward; and
an attainment reward.

6. The system of claim 1, wherein:
the network interface is further operable to receive a second message to create a second financial goal associated with the user, wherein the second message comprises the second financial goal and a reward for achieving the second financial goal and the second financial goal is available for display in a social networking environment associated with the user;
the processor is further operable to create the second financial goal associated with the user;
the memory is further operable to store the second financial goal; and
the processor is further operable to:
determine a priority between the first financial goal and the second financial goal; and
prioritize the first financial goal and the second financial goal according to the determined priority.

7. The system of claim 1, wherein the network interface is further operable to receive instructions according to location-based information of the user to create the first financial goal.

8. A method for performing financial activities in a social networking environment, comprising:
receiving a first message to create a first financial goal associated with a user, wherein the first message comprises the first financial goal and a reward for achieving the first financial goal and the first financial goal is available for display in a social networking environment associated with the user;
creating, by a processor, the first financial goal associated with the user;
storing the first financial goal;
monitoring a status of the first financial goal;
receiving information associated with the first financial goal from a data source;
updating, by the processor, the status of the first financial goal according to the received information.

9. The method of claim 8, further comprising:
determining whether a reward is associated with the updated status of the first financial goal;
if a reward is associated with the updated status, determining the reward; and
communicating a notification to a computer that indicates the reward.

10. The method of claim 8, further comprising:
receiving a message to update the first financial goal associated with the user, wherein the second message comprises at least one of the following:
an update to the first financial goal; and
an update to the reward.

11. The method of claim 8, further comprising:
determining completion of the first financial goal; and
determining the reward associated with the completed first financial goal.

12. The method of claim 8, wherein the reward comprises a selected one of the following:
an incremental reward;
an attainment reward.

13. The method of claim 8, further comprising:
receiving a second message to create a second financial goal associated with the user, wherein the second message comprises the second financial goal and a reward for achieving the second financial goal and the second financial goal is available for display in a social networking environment associated with the user;
creating, by the processor, the second financial goal associated with the user;
storing the second financial goal;
determining, by the processor, a priority between the first financial goal and the second financial goal;
prioritizing the first financial goal and the second financial goal according to the determined priority.

14. The method of claim 8, wherein receiving a first message to create a first financial goal comprises receiving instructions according to location-based information of the user to create the first financial goal.

15. Non-transitory computer readable medium comprising logic, the logic, when executed by a processor, operable to:
receive a first message to create a first financial goal associated with a user, wherein the first message comprises the first financial goal and a reward for achieving the first financial goal and the first financial goal is available for display in a social networking environment associated with the user;
create the first financial goal associated with the user;
store the first financial goal;
monitor a status of the first financial goal;
receive information associated with the first financial goal from a data source;
update the status of the first financial goal according to the received information.

16. The computer readable medium of claim 15, wherein the logic is further operable to:
determine whether a reward is associated with the updated status of the first financial goal;
if a reward is associated with the updated status, determine the reward; and
communicate a notification to a computer that indicates the reward.

17. The computer readable medium of claim 15, wherein the logic is further operable to:
receive a message to update the first financial goal associated with the user, wherein the second message comprises at least one of the following:
an update to the first financial goal; and
an update to the reward.

18. The computer readable medium of claim 15, wherein the logic is further operable to:
determine completion of the first financial goal; and
determine the reward associated with the completed first financial goal.

19. The computer readable medium of claim 15, wherein the logic is further operable to:
receive a second message to create a second financial goal associated with the user, wherein the second message comprises the second financial goal and a reward for achieving the second financial goal and the second financial goal is available for display in a social networking environment associated with the user;
create the second financial goal associated with the user;
store the second financial goal;
determine a priority between the first financial goal and the second financial goal;
prioritize the first financial goal and the second financial goal according to the determined priority.

20. The computer readable medium of claim 15, wherein the logic is further operable to receive instructions according to location-based information of the user to create the first financial goal.
